(19) United States
(12) Patent Application Publication
(10) Pub. No.: US 2008/0013052 A1
(43) Pub. Date: Jan. 17, 2008

(54) Projection Display Device

(75) Inventors: Ramon Pascal Van Gorkom, Eindhoven (NL); Marcellinus Petrus Carolus Michael Krijn, Eindhoven (NL); Siebe Tjerk De Zwart, Eindhoven (NL); Oscar Hendrikus Willemsen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,735

(22) PCT Filed: Aug. 31, 2005
(86) PCT No.: PCT/IB05/52846

§ 371 Date: Mar. 6, 2007

(30) Foreign Application Priority Data
Sep. 8, 2004 (EP) 04104318.3

(51) Int. Cl. G03B 21/14; G03B 21/00

(52) U.S. Cl. 353/38; 353/122

(57) ABSTRACT

The invention relates to a projection display device (10, 40, 60, 70) for casting an image onto a projection screen (26, 56, 86). The device comprises a spatial light modulator (16, 46, 62, 76) including an array of light modulating elements (18, 48, 78), and a light source (12, 42, 72) arranged to illuminate the modulator. The device is characterized in that each light modulating element of the modulator is illuminated by light diverging in a least one dimension, which light is spatially modulated by the modulator and cast onto the projection screen. An advantage with the projection display device according to the invention is that it can be realized in a very compact fashion. The invention further relates to a hand held device comprising such projection display device.

The present invention relates to a projection display device comprising a spatial light modulator including an array of light modulating elements and a light source arranged to illuminate the modulator. The invention further relates to a hand held device comprising such projection display device.

Projection display devices are used in for example portable video projectors, among others. A projection display device usually comprises a light source which is arranged to illuminate a modulator, or image display panel, which in turn modulates the incoming light with image information. The modulated light is then projected by a projection lens onto a projection screen. The light may be projected via a scanning mirror, for example a one-dimensional (1D) scanner in case the modulator is a 1D array of light modulating elements, in order to form a two-dimensional image. When a 2D modulator is used, the scanner can be omitted.

A projection display device comprising a one-dimensional light valve array and a one-dimensional scanning mirror is disclosed in the document U.S. Pat. No. 5,982,553. In U.S. Pat. No. 5,982,553, the light valve array is illuminated with collimated light. The light valve array includes modulator elements which diffract or reflect the incoming light, depending on whether the element is “ON” or “OFF”. The diffracted and reflected beams then pass through a projection lens. The reflected light beams converge to a focal point of the projection lens, at which a stop is placed intercepting the reflected beams. Diffracted light on the other hand converge at different focal points and passes the stop. The result is an image of the light valve array, i.e. a vertical or horizontal modulated line image, projected onto a projection screen, which line image is scanned by a scanning mirror to form a two-dimensional image.

However, the projection lens in U.S. Pat. No. 5,982,553 has to be the same size as the modulator in order to intercept the reflected beams. Further, the lens is placed at a distance equal to the focal length of the lens from the modulator in order to get a sharp picture at infinity. Also the stop has to be placed at approximately the focal length away from the lens. Hence the minimum path length from the modulator is about twice the focal length. The minimal focal length of the projection lens is in the order of the diameter of the lens, which means that the projection system cannot be made very compact. A compact projection display devices is desirable for example when it is to be used in a hand held device, such as a mobile phone.

Also in the case of a projection display device having a two-dimensional modulator, for example an LCD-panel, a projection lens having at least the same size as the modulator is needed. The lens should be placed at the distance of about the focal length of the lens from the panel. Thus, a considerable volume is still taken by the projection system.

It is an object of the present invention to provide an improved projection display device, which can be realized in a compact fashion.

This and other objects that will be evident from the following description are achieved by means of a projection display device by way of introduction, wherein each light modulating element of the modulator is illuminated by light diverging in a least one dimension, which light is spatially modulated by the modulator.

The light illuminating the modulator panel is diverging in the sense that the range of angles under which the light hits a light modulating element does not overlap with the range of angles the light hits other light modulating elements.

An advantage with the projection display device according to the invention is that it can be realized in a very compact fashion.

According to a first embodiment of the present invention, the spatially modulated light from the modulator panel is divergently cast onto a projection screen, without passing any projection lens. Thus, the projection display device works basically as a shadow play where an image is created by effectively casting a shadow of the modulator panel on the projection screen. This means that the image on the modulator panel is not optically focused in any particular plane, such as the projections screen. As no projection lens is required it is possible to construct a very compact projection system, which is especially advantageous if the projection display device is incorporated in a hand held device where weight and size is an issue. Also, the absence of a projection lens makes the projection display device cheaper to manufacture.

Preferably, an angle of diffraction at each light modulating element is less than or equal to the angle between two adjacent light modulating elements, as seen from the light source. This can for example be realized by providing the light modulating elements in a certain size. Even more preferably, the angle of diffraction at each light modulating element is less than or equal to half the angle between two adjacent light modulating elements, as seen from the light source.

Conventionally, when a modulator panel is illuminated with collimated light, the diffraction at each light modulating element or pixel in the panel causes a change in angle under which the light beams leave the panel. This in turn causes a beam leaving the panel, at a certain distance from the panel, to completely cover light from a neighboring pixel, whereby the maximum distance from the panel where the image is sharp is limited. However, by illuminating the panel with diverging light, according to the invention, and by having the diffraction angle less than or equal to the angle between adjacent pixels, this can be avoided and the image is sharp at any distance from the panel. Thus, a cast image having an infinite “focal depth” can be obtained.

An advantage with the infinite “focal depth” is that the projection display device can be moved towards or away from the projection screen, or vice versa, without disrupting the cast image. This is particularly advantageous if the projection display device is incorporated in a hand held device, such as a mobile phone, which tends to move irregularly when hold by a user.

The projection display device can further comprise a control device arranged to receive image data and to control the modulator. Preferably, in the first embodiment of the invention, the control device is adapted to control the light modulating elements (or pixels) of the modulator based on that received data and the diffraction patterns of light at each light modulating element, in order to best image the picture on the projection screen.

Even though the cast image has infinite “focal depth” as explained above, the diffraction which is due to the boundaries of the pixels may limit the resolution of the image. However, the edge of a group of pixels in the ON state becomes sharper than the edge of a single pixel in the ON state. It is hence possible to enhance the cast image by selectively switching certain pixels ON and certain pixels OFF or by adjusting the gray scale. What pixels to adjust is advantageously decided based on the diffraction patterns for light beams at each pixel of the modulator panel. How the cast image will look can preferably be predicted by using Fourier optic methods. Thus, by adjusting the panel content taking into account the diffraction patterns of light at each light modulating element, the cast image can be improved, and a reasonably high quality image can be obtained.

It should be noted that the adjustment of the panel content can be used to limit the effects of diffraction also in the case where the cast image has a limited “focal depth”, i.e. if the condition regarding the diffraction angle and the angle between adjacent pixels as stated above is not met.

According to a second embodiment of the present invention, the projection display device further comprises a segmented projection lens for projecting light from the modulator onto a projection screen. Thus, the segmented projection lens is preferably arranged between the modulator panel and the projection screen.

The segmented projection lens is for example an array of small projection lenses, each lens being associated with a set of light modulating elements, i.e. a subset of the modulator panel, for example 10 by 10 light modulating elements or pixels. Thus, each lens is arranged to focus light from a set of light modulating elements and the projection display device according to this second embodiment is effectively an array of small projections displays.

Like the conventional single projection lens according to prior art described above, the segmented projection lens is placed at a distance equal to the focal length of the lens from the modulator, to focus the image at “infinity”. However, the focal length of each lens in the segmented projection lens can be made shorter than the focal length of an equivalent single projection lens. The focal length for each projection lens is in the order of the radius of the lens. Consequently, the segmented projection lens can be placed closer to the modulator panel and the projection display device utilizing a segmented projection lens can be realized in a more compact fashion at the same time as the resolution is the same as when using the conventional projection lens. Also, since each lens of the segmented lens is smaller than an equivalent conventional lens, the segmented lens also becomes thinner and the whole lens becomes more compact. Also, the segmented lens can be used to reduce adverse effects of a small overlap of the light at each pixel.

It should be noted that it is not possible to use the segmented lens with collimated, non-diverging incoming light since the images from the separate lenses would overlap.

Preferably, the light source of the projection display device according to the invention comprises beam shaping optics, which can be adapted to transform the light from the light source into diverging light for illumination of the modulator panel. In case of a 1D panel the light is preferably transformed into light diverging in one dimension, and in case of a 2D panel the light is preferably transformed into light diverging in two dimensions.

The modulator of the projection display device can be of transmissive or reflective type. In the former case, the modulator panel is illuminated from the back side of the panel, and in the latter case, the modulator is illuminated from the front side.

In one embodiment of the invention, the modulator is a 1D modulator panel, i.e. it comprises a one-dimensional array of light modulating elements. The 1D modulator generates a line image, which line image is scanned, for example by a scanning mirror, in order to form a 2D-image.

The 1D modulator can for example be a one-dimensional array of foil bar light valves. For example, each light valve can be arranged to reflect or scatter incoming light, depending on whether the light valve is in its ON state or OFF state. Means are further provided for filtering light modulated by the 1D modulator so that only light beams from light valves (i.e. pixels) in the ON state are cast upon the projection screen. The means for filtering light can for example be a diaphragm.

Also other types of foil bar light valves can be used, as well as grating light valves (GLVs), Kodak GEMS, a 1D transmissive LCD panel, a 1D reflective LCD panel, or a 1D digital mirror device (DMD).

In another embodiment of the invention, the modulator is a two-dimensional panel, whereby a shadow of the panel is cast onto a projection screen, forming a 2D image. In this embodiment, the scanning mirror can be obviated. The 2D-panel can for example be a transmissive LCD panel, a reflective LCD panel, or a digital mirror device (DMD).

Preferably, the light source is at least one laser source. An advantage with a laser source is that it has very low etendue, i.e. it is a good point source. In case color images are to be cast, three lasers of different colors can be used in order to sequentially illuminate the modulator panel with different colors, whereby a color image can be formed. As an alternative to the laser source(s), an UHP lamp or a LED source can be used, for example.

According to another aspect of the invention, a hand held device is provided, which comprises a projection display device according to the above description. The hand held device can for example be a mobile phone.

These and other aspects of the present invention will be described in more detail in the following, with reference to the appended figures showing presently preferred embodiments.

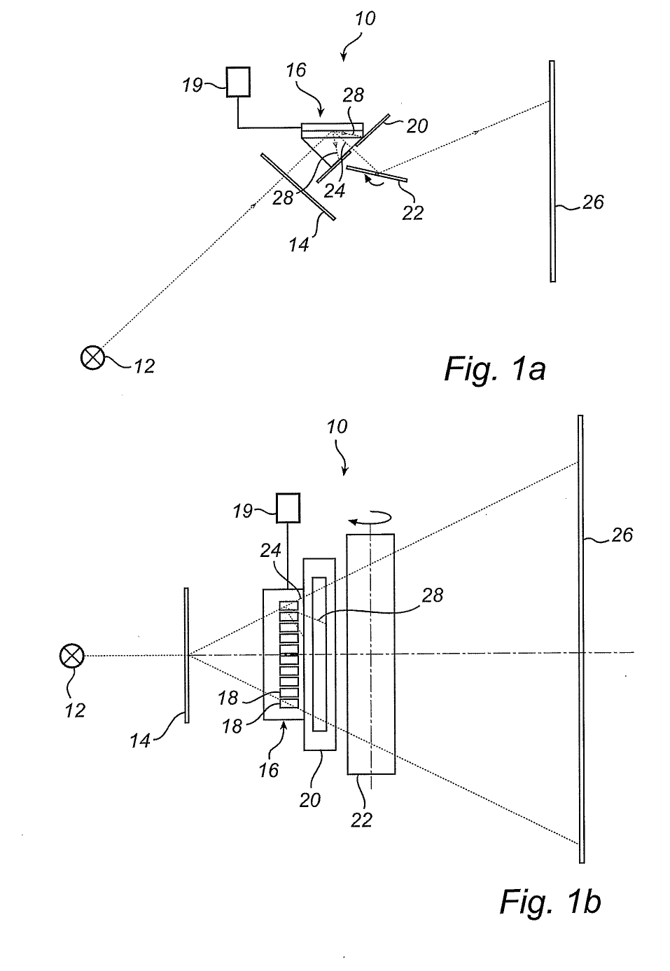

FIG. 1a is a schematic top view of a projection display device according to a variant of a first embodiment of the invention comprising a 1D modulator and a scanning mirror,

FIG. 1b is a schematic side view of the projection display device of FIG. 1a,

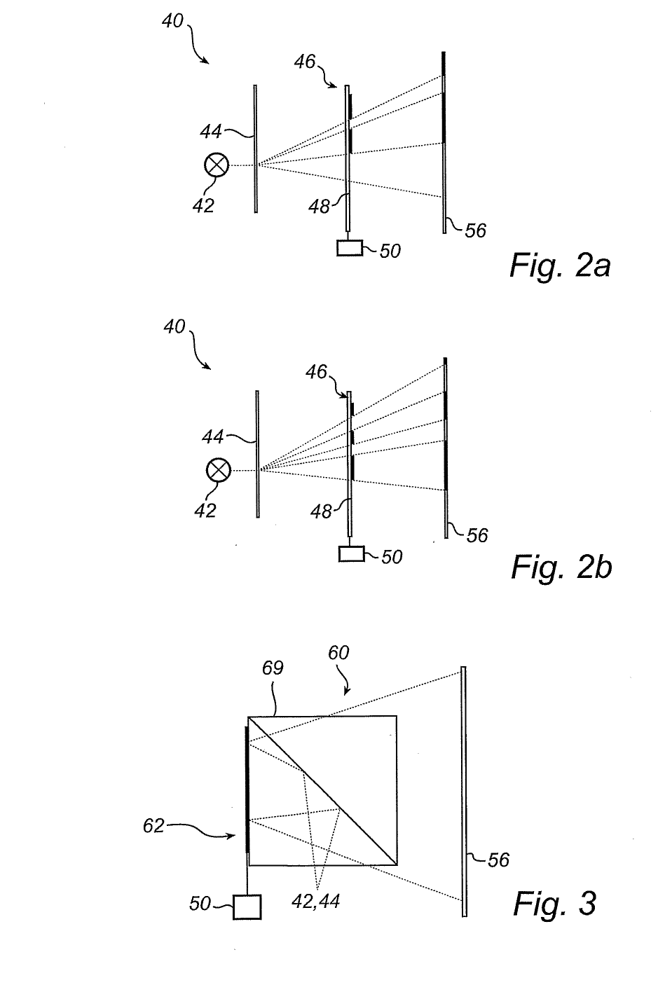

FIG. 2a is a schematic top view of a projection display device according to another variant of the first embodiment of the invention comprising a transmissive 2D modulator panel,

FIG. 2b is a schematic side view of the projection display device of FIG. 2a,

FIG. 3 is a schematic side view of a projection display device according to the invention comprising a reflective 2D modulator panel, and

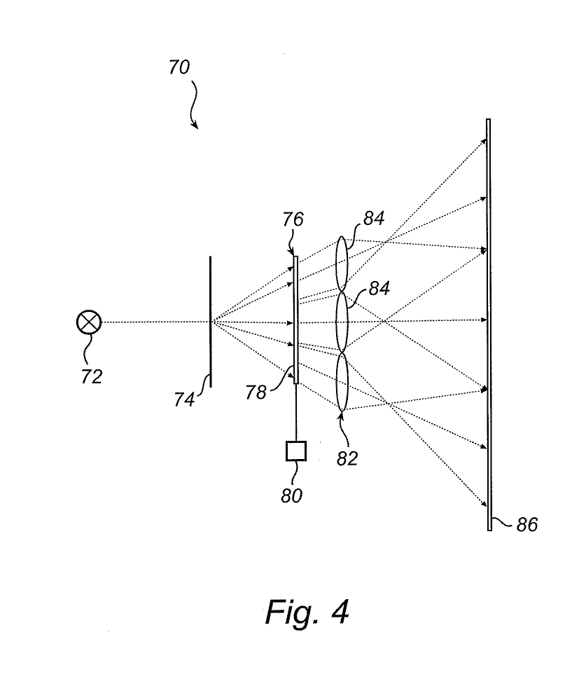

FIG. 4 is a schematic side view of a second embodiment of the invention comprising a segmented projection lens.

FIGS. 1a and 1b show a projection display device 10 according to a variant of a first embodiment of the present invention. The projection display device 10 comprises a laser light source 12, beam shaping optics 14, a spatial light modulator 16 including a one-dimensional array of light modulating elements 18, a control device 19 for receiving image data and for controlling the modulator 16, a slit diaphragm 20, and a scanning mirror 22.

The light modulating elements 18 of the 1D modulator 16 are in this case foil bar light valves, such as described in the international patent application IB2004/051220. Each light modulating element 18 is constructed to specularly reflect incident light or to scatter incident light in all directions, depending on whether the element 18 is in its ON state or OFF state, i.e. whether the pixel is bright or dark. The specularly reflected light is known as the 0^{th} order mode.

Upon operation of the projection display device 10, light generated by the light source 12 is transformed into light diverging in one dimension using the beam shaping optics 14 to illuminate the array of light modulating elements 18. The light incident on the array of light modulating elements 18 is diverging in a dimension corresponding to the length direction of the array of light modulating elements 18, as can be seen in FIG. 1b.

The modulator 16 is arranged to receive the diverging light and spatially modulate it to form a line image. After passing the array of light modulating elements 18, beams of scattered light 28 from the pixels in the OFF state are intercepted by the slit diaphragm 20. On the other hand, the beams of reflected light 24 from the pixels in the ON state are led through the slit diaphragm 20, and are cast onto a projection screen 26. The result is a vertical (or horizontal) spatially modulated line image cast on the screen 26. This line image is further scanned to form a two-dimensional image by using the rotating scanning mirror 22.

As can be seen from FIG. 1a, the beams from the light source 12 that are specularly reflected by the array of light modulating elements 18 are diverging all the way from the beam shaping optics 14 to the screen 26. The projection display device 10 does not comprise any projection lens for projecting the image onto the projection screen, whereby the projection display device 10 can be realized in a compact fashion.

As an alternative to the specific foil bar light valves mentioned above, other foil bar light valves can be used. Also grating light valves (GLVs) or Kodak GEMS can be used, in which case each light valve is arranged to reflect or diffract incoming light, as described in for example U.S. Pat. No. 5,982,553 mentioned above. In that case, the diaphragm can be replaced by a beam stop, which blocks reflected light and lets diffracted light of the 1^{st} order mode pass. Also second and higher order modes are preferably filtered out.

As yet another alternative, a 1D transmissive LCD panel, a 1D reflective LCD panel, or 1D digital mirror device (DMD) can be used as a modulator. In case of an LCD panel, no diaphragm is needed. For the 1D reflective LCD panel and the 1D digital mirror device (DMD), the setup is similar to the display projection system shown in FIGS. 1a and 1b. In case of the transmissive LCD panel, the light source is placed behind the modulator panel.

FIGS. 2a and 2b show a projection display device 40 according to another variant of the first embodiment of the present invention. The projection display device 40 comprises a laser light source 42, beam shaping optics 44, a transmissive spatial light modulator 46, for example a transmissive LCD panel, including a two-dimensional array of light modulating elements 48, and a control device 50 for receiving image data and for controlling the modulator 46. Each light modulating element 48 of the modulator 46 is arranged transmit incoming light if the element or pixel is “ON” and to intercept incoming light if the element is “OFF”.

Upon operation of the projection display device 40, light generated by the light source 42 is transformed into light diverging in two dimensions using the beam shaping optics 44 to illuminate the modulator 46, as indicated in FIGS. 2a and 2b.

The modulator 46 is arranged to receive the diverging light and spatially modulate it to form a two-dimensional image. Light beams incident on pixels in the ON state are transmitted through the modulator panel 46 and are cast upon a projection screen 56, while light beams incident on pixels in the OFF state are intercepted, and hence do not reach the screen 56. Thus, an image is created by effectively casting a shadow of the modulator panel 46 on the projection screen 56.

As the device 10 of FIGS. 1a and 1b, this projection display device 40 functions without a projection lens, which again allows for a compact projection display device.

The transmissive 2D modulator panel in FIGS. 2a and 2b can be replaced by a reflective 2D panel, such as a reflective LCD panel or a digital mirror device (DMD). In this case, the panel has to be illuminated from the front side. FIG. 3 shows an example of a setup of a projection display system 60 according to the invention comprising a reflective 2D panel 62, wherein a polarizing beam splitter 69 is used to direct light from the light source and beam shaping optics 42, 44 onto the modulator panel 62. In case of a DMD panel, a ¼-λ plate should also be incorporated in order to rotate the polarizing direction.

As mentioned above, the projection display device according to the first embodiment of the invention does not comprise any projection lens. This means that the resolution of the cast image is limited. The reason for this is the diffraction of the light at each pixel of the modulator panel.

The smallest feature that can be displayed is found from the diffraction limit. The change in angle of a light beam due to diffraction at a pixel is in the order of θ=λ/d, where θ is the change in angle, λ is the wavelength of the light, and d is the pixel pitch. In order to derive the minimum pixel size, the change in angle θ has to be the same as the change in angle φ, as seen from the light source, when moving between one pixel to the adjacent pixel: φ=d/L, where φ is the angle, and L is the (effective) distance of the light source to the panel. Setting φ=θ yields θ=\sqrt{λ/L} and d=\sqrt{λL}. Thus for e.g. green light with λ=500 nm with a light source 2 cm behind the panel, this will yield 0.1 mm pixels at the modulator panel. For a 2 cm high panel, it is possible to display about 200 pixels below each other. The pixel size at a projection screen is further given by θLₜₒₜ=Lₜₒₜ\sqrt{λ/L}, where Lₜₒₜ is the distance between the light source and the projection screen. For a distance of 10 cm between the light source and the projection screen, this will yield a pixel size of 0.5 mm.

However, depending on the size of the pixel, the edge of a group of pixels in the ON state becomes sharper than the edge of a single pixel in the ON state. It is hence possible to enhance the cast image by selectively switching certain pixels ON and certain pixels OFF, or by adjusting the gray scale. Preferably, what pixels to adjust should be decided based on the diffraction patterns for light beams at each pixel of the modulator panel. How the cast image will look can be predicted by using Fourier optic methods. Thus, by adjusting the panel content taking into account the diffraction patterns, the cast image can be improved, and a reasonably high quality image can be obtained.

A way to further improve the quality of the cast image is to make the boundaries between pixels very small in such a way that the interference pattern resulting from the pixel boundaries is negligible, i.e. make a continuum of pixels. For example, in case of a transmissive LCD modulator panel, this could be realized by adding a lens array at both sides of the modulator panel. Also GLVs and Kodak GEMS, which effectively have a continuum of pixels, could be used.

FIG. 4 shows a projection display device 70 according to a second embodiment of the present invention. The projection display device 70 comprises a laser light source 72, beam shaping optics 74, a transmissive spatial light modulator 76, for example a transmissive LCD panel, including a two-dimensional array of light modulating elements 78, a control device 80 for receiving image data and for controlling the modulator 76, and a segmented projection lens 82 including an array of small projection lenses 84. Each light modulating element 78 of the modulator 76 is arranged transmit incoming light if the element or pixel is “ON” and to intercept incoming light if the element is “OFF”.

As described above in relation to FIGS. 2a and 2b, light generated by the light source 72 is transformed into light diverging in two dimensions using the beam shaping optics 74 to illuminate the modulator 76.

The modulator 76 is arranged to receive the diverging light and spatially modulate it to form a two-dimensional image. Light beams incident on pixels in the OFF state are intercepted, and hence do not reach the segmented projection lens 82, while light beams incident on pixels in the ON state are transmitted through the modulator panel 76 and are projected by means of the segmented projection lens 82 onto a projection screen 86. The resolution of the projected image is the same as when using a conventional non-segmented projection lens, at the same time as the segmented projection lens 82 can be placed closer to the modulator 76 due to the shorter focal length of each projection lens 84. The focal length is in the order of the radius of the projection lens 84.

Due to each lens 84 of the segmented projection lens 82, the pixels on the screen are reversed from top to bottom and left to right for each lens 84. Therefore, the panel contents has to be adjusted accordingly by means of the control device 80.

It should be noted that the segmented projection lens 82 is somewhat larger than the modulator panel 76 due to the light diverging from the panel 76 to the segmented projection lens 82. Also, the lenses 84 may slightly overlap in order to reduce any visibility of the edges of the lenses 84 in the projected image.

For both embodiments of the projection display device described above, color can be realized according to known techniques. For example, the light source illuminating the modulator panel can comprise three lasers of different colors, whereby each of the three colors can be cast sequentially so that a color image can be formed, or color filters can be employed, etc.

The invention is not limited to the embodiments described above. Those skilled in the art will recognize that variations and modifications can be made without departing from the scope of the invention as claimed in the accompanying claims. For example the segmented projection lens can alternatively be used with a 1D modulator panel, such as the light valve array described in relation to FIGS. 1a and 1b.

1. A projection display device (10, 40, 60, 70), said device comprising:
a spatial light modulator (16, 46, 62, 76) including an array of light modulating elements (18, 48, 78) and
a light source (12, 42, 72) arranged to illuminate said modulator,
characterized in that each light modulating element of the modulator is illuminated by light diverging in a least one dimension, which light is spatially modulated by the modulator.

2. A projection display device according to claim 1, wherein said spatially modulated light is divergently cast onto a projection screen (26, 56).

3. A projection display device according to claim 2, wherein an angle (θ) of diffraction at each light modulating element is less than or equal to the angle (φ) between two adjacent light modulating elements, as seen from the light source.

4. A projection display device according to claim 2, further comprising a control device (19, 50) arranged to receive image data and to control said modulator (16, 46, 62),
said control device being adapted to control the light modulating elements (18, 48) of the modulator based on said received image data and the diffraction patterns of light at each light modulating element.

5. A projection display device according to claim 1, further comprising a segmented projection lens (82) for projecting light onto a projection screen (86).

6. A projection display device according to claim 5, wherein said segmented projection lens (82) comprises an array of projection lenses (84), each projection lens (84) being associated with a set of light modulating elements.

7. A projection display device according to claim 1, wherein said light source comprises beam shaping optics (14, 44, 74).

8. A projection display device according to claim 1, wherein said modulator (16, 46, 62, 76) is transmissive or reflective.

9. A projection display device according to claim 1, wherein said modulator is a 1D modulator (16), and wherein the device further comprises means (22) for scanning the light modulated by said modulator to form a 2D image.

10. A projection display device according to claim 9, wherein said 1D modulator (16) is a one-dimensional array of foil bar light valves, and wherein said projection display device further comprises means (22) for filtering light modulated by the 1D modulator.

11. A projection display device according to claim 1, wherein said modulator is a 2D modulator (46, 62, 76).

12. A projection display device according to claim 11, wherein said 2D modulator (46, 62, 76) is one of transmissive LCD panel, reflective LCD panel, and digital mirror device.

13. A projection display device according to claim 1, wherein said light source (12, 42, 72) is at least one laser source.

14. A handheld device, comprising a projection display device according to claim 1.

15. A handheld device according to claim 14, wherein said handheld device is a mobile phone.
